(19) United States
(12) Patent Application Publication
(10) Pub. No.: US 2006/0175181 A1
(43) Pub. Date: Aug. 10, 2006

(54) Reduced friction roller support for modular link conveyor chain

(76) Inventors: James L. Layne, Bowling Green, KY (US); Michael D. McDaniel, Glasgow, KY (US)

Correspondence Address: KING & SCHICKLI, PLLC, 247 NORTH BROADWAY, LEXINGTON, KY, 40507, US

(21) Appl. No.: 11/347,864

(22) Filed: Feb. 6, 2006

Related U.S. Application Data
(60) Provisional application No. 60/650,266, filed on Feb. 4, 2005.

(51) Int. Cl. B65G 17/00

(52) U.S. Cl. 198/841

(57) ABSTRACT

A conveyor system moves one or more articles in at least a conveying direction along an endless path having a forward run and a return run. The system includes an endless chain having lateral side edges spaced apart in a direction transverse to the conveying direction, and at least one link having a surface intermediate of the side edges. A chain support positioned between the side edges includes an axle extending in the transverse direction for rotatably supporting a roller for engaging the surface of the link. The roller provides enhanced, low friction support for the chain intermediate of the side edges.

This application claims the benefit of U.S. Provisional Patent Application. Ser. No. 60/650,266, filed Feb. 4, 2005, the disclosure of which is incorporated herein by reference.

### TECHNICAL FIELD

This invention relates generally to the conveyor art and, more particularly, to any modular link conveyor chain that may benefit from having reduced friction support.

### BACKGROUND OF THE INVENTION

The use of modular link conveyors in industry enjoys increasing popularity. Particularly for conveying food articles or consumer products, especially in packages or in semi-packaged form, the modular link conveyor represents the overwhelming choice of those in the industry looking for a long-lasting, low cost conveying solution. In the recent past, significant advances in the development of such conveyors have been made so as to provide more efficient handling of an even larger variety of food articles, packages and containers, as well as other types of articles and products.

One of the most popular and reliable types of modular link conveyor systems on the market today is manufactured and sold by the assignee of the present invention under THE DESIGNER SYSTEM and WHISPERTRAX trademarks, and illustrated and claimed in prior U.S. Pat. No. 4,953,693, Sep. 4, 1990 and U.S. Pat. No. 5,031,757, issued Jul. 16, 1991 (both of which patents are fully incorporated herein by reference). Since the time of these early patents in the art, significant advances have been fast in coming to provide an even more efficient operation and better handling and transporting of articles and products. For example, Applicant's later U.S. Pat. Nos. 6,364,095 and 6,585,110 (which are also incorporated herein by reference) propose the inclusion of one or more rollers in a selected link in the chain, thus improving the performance in terms of reducing friction while optionally retaining the side-flexing and longitudinal compression benefits afforded by the basic design shown in the '693 and '757 patents.

Despite eliminating the often troublesome catenary approach prevalent in the prior art and providing the often desirable secure holding along the sides by the guide links, a problem sometimes arises with sagging of the conveyor chain intermediate of the sides. This sagging is especially prevalent when a particular width of modular link chain is reached or exceeded. For example, in the case of a modular link chain with links styled similar to those shown in the '693 patent and with a four millimeter diameter stainless steel connector rod, the cutoff width is about twenty-five inches or more. Increasing the diameter of the connector rod is not an option without redesigning the corresponding link (which would then preclude retrofitting).

To prevent sagging of the chain intermediate of the side guide links, the solution practiced for many years is to provide support intermediate of the sides of the chain. In the past, such support has been provided by structures such as curved or “serpentine” rails spanning in the longitudinal direction (see, e.g., U.S. Pat. No. 5,190,145 to Ledginham et al.). These structures contact either the conveying surface along the return run or the opposite (underside) surface of the chain along the forward run, and thus provide the desired intermediate support.

One problem with this approach is that the engagement between the chain and the support structure(s) increase the frictional force acting on the belt or chain, especially when articles are present (such as along the forward run). The drag created through the engagement thus retards the forward movement of the chain, thus increasing the power required to drive it along the endless path. Since the available power directly corresponds to the permissible length of the chain in the conveying direction, a limit exists that can only be overcome by increasing the size of the motor, adding multiple motors, or providing an intermediate drive to assist the regular one. However, these approaches all tend to increase not only the operating costs in terms of the increased power consumption required to drive the chain, but also the manufacturing and maintenance costs.

Accordingly, a need is identified for an improved arrangement for supporting a modular link conveyor chain. In one version, the arrangement would be capable of supporting the chain intermediate of the sides without increasing to any significant degree the frictional force. As a result, not only would the power required for driving the chain be minimized, but a longer chain could be driven along an endless path using the same power source presently required for a much shorter one. Existing conveyor systems would thus be readily susceptible to retrofitting using this invention, which would at a minimum reduce the power requirements and thus possibly extend the service life of the particular driver used.

### SUMMARY OF THE INVENTION

In accordance with one aspect of the invention, a conveyor system intended for use in moving one or more articles in at least a conveying direction along an endless path having a forward run and a return run is disclosed. The system comprises an endless chain having lateral side edges spaced apart in a direction transverse to the conveying direction and including at least one link having a surface intermediate of the side edges. A chain support positioned between the side edges and including an axle extending in the transverse direction rotatably supports a roller for engaging the surface of the link. The roller provides enhanced, low friction support for the chain intermediate of the side edges.

In one embodiment, the chain support comprises a rail extending in the conveying direction and a plurality of spaced apart axles. Each axle carries a roller for engaging the surface of the link as the chain moves in the conveying direction. Preferably, each axle comprises a stub shaft projecting outwardly from the rail and includes a retainer at one end for retaining the associated roller. The axles may be spaced apart a distance in the conveying direction less than twice the diameter of the associated roller, which are thus considered closely spaced.

In one possible approach to the invention, the surface of the link for engaging the roller is opposite a conveying surface of the chain, in which case the support is positioned along the return run. The chain may include side guide links for engaging corresponding side guide rails extending in the conveying direction and spaced apart in the transverse direction. These guide rails may carry the chain support, and each side guide link may include a transverse tab for engaging a corresponding one of the side guide rails. Each side guide rail may include at least one roller for providing low friction support along the side edge of the chain.

In accordance with a second aspect of the invention, a conveyor system intended for use in moving one or more articles in at least a conveying direction along an endless path having a forward run and a return run is disclosed. The system comprises an endless chain having lateral side edges formed by rows of modular links, including side and intermediate links, interconnected by a connector extending in a direction transverse to the conveying direction. A chain support includes an axle extending in the transverse direction for rotatably supporting a roller for engaging a surface of at least one intermediate link as the chain traverses the endless path. Consequently, the roller provides enhanced, low friction support for the chain intermediate of the side edges to help prevent sagging.

In one approach, the surface of the at least one intermediate link is opposite a conveying surface along the return run. The support may comprise a guide rail extending in the conveying direction. This guide rail preferably carries a plurality of closely spaced rollers to provide low friction support for the chain by engaging the surface of the intermediate links as the chain traverses the endless path.

In accordance with another aspect of the invention, a support arrangement for a modular conveyor chain moving in a conveying direction and including at least one link is disclosed. The arrangement comprises a longitudinally extending rail including a plurality of rollers spaced in the conveying direction for engaging the chain and providing direct, low-friction support. A space between the rollers in the conveying direction is less than a dimension of the link in the conveying direction.

In accordance with yet another aspect of the invention, a support arrangement for a modular conveyor chain moving in a conveying direction and including at least one link is disclosed. The support arrangement comprises a longitudinally extending rail including a plurality of rollers spaced in the conveying direction for engaging the chain and providing direct, low-friction support. The plurality of rollers simultaneously contact the at least one link.

In accordance with still another aspect of the invention, a support arrangement for a modular conveyor chain is disclosed. The arrangement comprises a support frame including first and second spaced apart side members for at least supporting the chain. An intermediate rail positioned between the spaced rails supports at least one axle carrying at least one roller for engaging the chain.

In one embodiment, the intermediate support rail carries a plurality of axles spaced apart in the conveying direction, each carrying a roller for engaging the chain. The side members may include wear strips for engaging the conveyor chain. The side members may also include rollers for engaging the conveyor chain. Each axle is a stub axle and includes a retainer for retaining the corresponding roller, and the intermediate support rail is carried by the side members.

In accordance with a further aspect of the invention, a method of manufacturing a support arrangement for a modular conveyor chain having side edges is disclosed. The method comprises positioning a longitudinally extending rail between the side edges of the chain, the rail including an axle supporting at least one roller for engaging the chain.

In accordance with yet a further aspect of the invention, a method of manufacturing a conveyor system is disclosed. The method comprises forming an endless conveyor chain of a plurality of modular links, including by passing a transverse connector through the links to form a row; and supporting the endless chain, including with a longitudinally extending rail positioned between the side edges of the chain and having an axle supporting a roller for engaging the chain.

### BRIEF DESCRIPTION OF THE DRAWINGS

FIG. 1 is a partially schematic side view of an overall conveyor system;

FIG. 2 is a cross-sectional view taken along line 2-2 of FIG. 1;

FIG. 3 is a cutaway, partially cross-sectional view of a wear strip associated with the guide rail for engaging a side link of the conveyor chain;

FIG. 4a is a perspective view of an exemplary side link;

FIG. 4b is a cross-sectional side view of the side link;

FIG. 4c is a cross-sectional side view of a tab for engaging a transverse connector;

FIG. 5 is a partially cross-sectional end view of the modular link conveyor system including roller support rails for the upper and lower runs;

FIG. 6 is a top cutaway view showing the side-flexing capability of one embodiment of the disclosed conveyor chain;

FIG. 7 is a partially cross-sectional end view of another modular link conveyor system including roller support rails for the upper and lower runs;

FIG. 8 is a perspective view of the roller support rail;

FIG. 9 is a side view of the roller support rail of FIG. 8;

FIG. 10 is a top view of the roller support rail of FIG. 8;

FIG. 11 is an enlarged end view of the roller support rail of FIG. 8;

FIG. 12 is an enlarged perspective view of a roller associated with the roller support rail of FIG. 8;

FIG. 13 is an enlarged side view of a stub shaft serving as an axle for the roller in the support rail of FIG. 8; and

FIG. 14 is an enlarged side view of the retainer for retaining the roller on the axle of the support rail of FIG. 8.

### DETAILED DESCRIPTION OF THE INVENTION

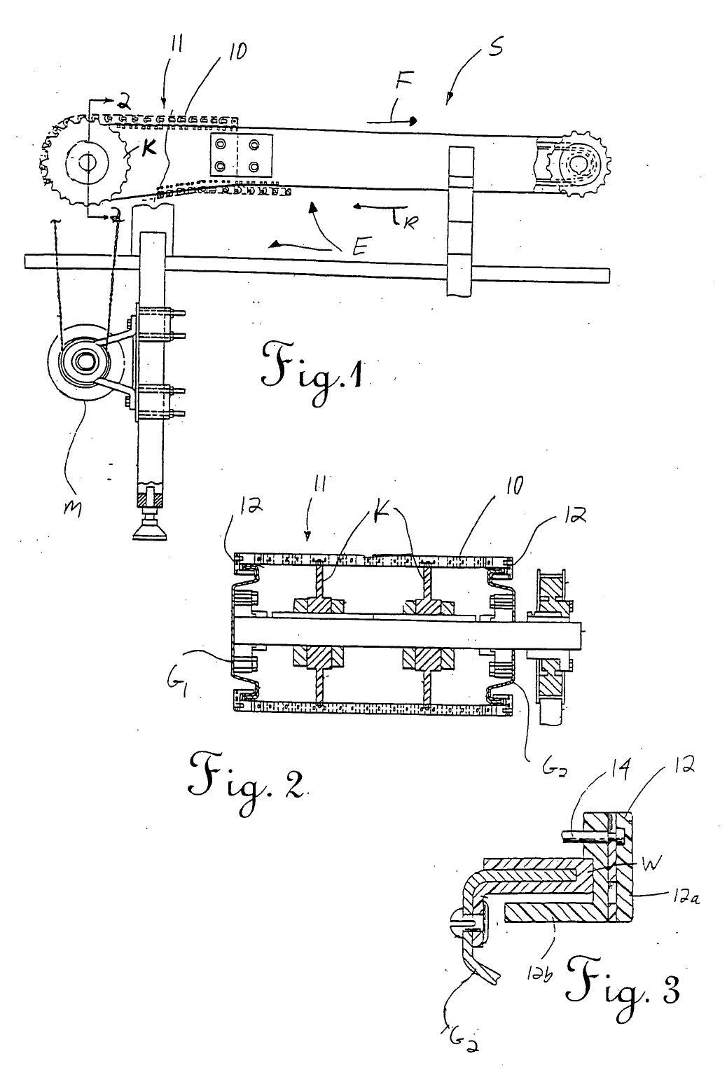

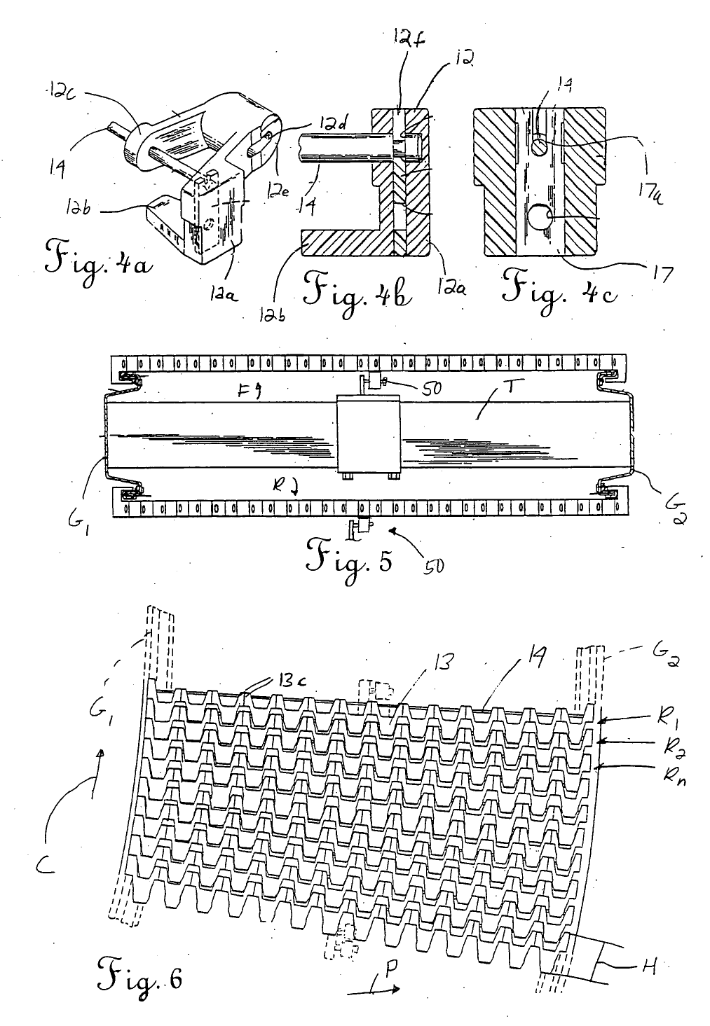

Reference is now made to FIGS. 1 and 2, which depict an overall conventional arrangement of a possible conveyor system S including a chain 10. The chain 10 includes a conveying surface 11 for engaging and supporting articles. In this particular embodiment, the chain 10 comprises or includes modular links including side guide links 12 and intermediate links 13 arranged in spaced apart rows (see FIG. 6 and note rows R₁ . . . Rₙ) which thus partially create the conveying surface 11. Adjacent rows R₁, R₂ of links are interconnected by transversely extending connectors 14, which are also referred to in the vernacular as “cross rods.”

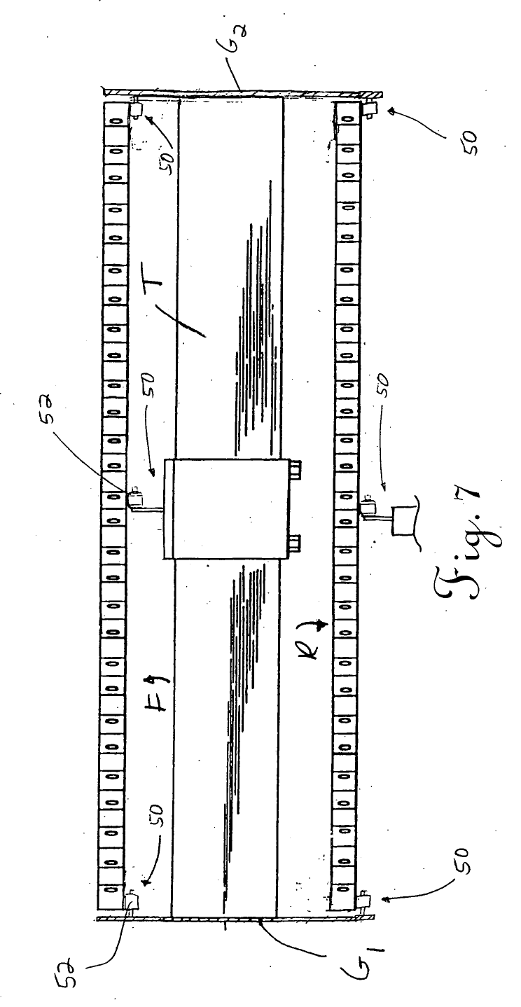

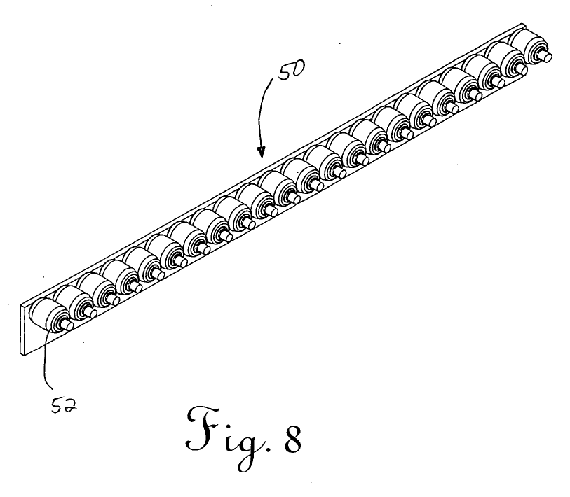

With regard to the side links 12, and as perhaps best understood by viewing FIGS. 3 and 4a-4c, each may include an outer depending arm 12a and an inwardly projecting or extending transverse tab 12b (thus creating different right handed or left handed side links, depending on the particular positioning). When present, the depending arm 12a and transverse tab 12b are designed to receive a conventional support structure, which may include a longitudinally extending guide rail G₁ or G₂ forming part of the conveyor support frame E (see FIGS. 4 and 5b). These guide rails G₁, G₂ support the chain 10 along both the forward run F and the return run R as it is bidirectionally driven in an endless path (such as by spaced sprockets K adapted for engaging the links along a transition from a forward run F to a return run R and gang-driven by an associated motor M).

Each guide rail G₁ or G₂ preferably includes a wear strip W formed of a tribologically enhanced material to provide reduced friction contact with the links 12. The guide rails G₁ or G₂ may be C-shaped or sigma shaped, as shown in FIGS. 2 and 5, or instead may simply include one or more support sections of any desired shape carrying the associated wear strips W such that they project outwardly therefrom like a tongue or tenon and thus define a bearing surface for the chain 10 (and, in particular, the side guide links 12). Associated links of the sort mentioned are typically formed of complementary or matched materials, such as Nylon 6-6, Acetal, or other inexpensive, lightweight, and durable materials using well-known forming techniques (including possibly co-molding of different materials). Although performance of the system 10 may be improved as a result, matching of the materials forming the links and guide rails (wear strips) is not considered a requirement.

Preferably, pairs of side links 12 together with intermediate links 13 form rows spaced apart in the direction in which the chain 10 is typically driven (referred to as the longitudinal direction or the conveying direction (note action arrow C in the plan view of FIG. 6), since it corresponds to the main direction in which articles are conveyed by the chain 10 during normal operation, as opposed to the transverse or lateral direction P). To interconnect the pairs of links 12 forming a first (leading) row R₁, the transverse connector 14 takes the form of a stainless steel rod passing through aligned holes (see FIG. 6) formed in foot portions 13c of each intermediate link 13 (which may be more than two in cases where each link has plural laterally repeating sections), including the side link 12. During construction of the chain 10, the links 12, 13 of a second, adjacent (trailing) row R₂ are interdigitated with those of the first row R₁, with the connector 14 passing through a slot 12d elongated in the conveying direction C and formed in the apex 12e of each link 12, 13 in the second row.

As should be appreciated by those of skill in the art, this specific structural arrangement (which is considered entirely optional) allows for the chain 10 to side-flex to negotiate curves or bends (see FIG. 6), as well as to compress or expand in the longitudinal direction, and thus eliminates the need for a catenary. If such enhanced functionality is not necessary for a particular application, the slots 12e could simply be replaced with plain holes for receiving the connector 14, which would this result in a non-side flexing, non-longitudinally compressible chain. In such case, the interdigitated links 12 may also include a flat top surface, as shown in Applicant's later U.S. Pat. Nos. 6,364,095 and 6,585,110.

In any case, the connector 14 is retained in place by a locking element or tab 16 removably inserted in a receiver 12f or slot formed in each side link 12. As shown in FIG. 4c, the tab 17 may include a recess 17a for engaging a necked or recessed portion 14a of the connector 14. This pattern of assembly may be repeated among the interdigitated links 12, 13 as necessary to form a chain 10 having a particular length in the conveying direction. A full description of this type of chain or “belt” as it is sometimes called in the vernacular, is found in the commonly assigned '693 and '757 patents, the disclosures of which are fully incorporated herein by reference.

With continued reference to FIG. 5 and further reference to FIG. 7, one aspect of the invention comprises providing a longitudinally extending support 50 including one or more spaced rollers 52 intermediate of the side links 12 along the edges of the chain 10. The rollers 52 thus provide low friction support along either the forward run F, the return run R, or both. In FIG. 5, the roller support 50 shown in use with a chain 10 including the special side guide links 12 described above including special side frame members forming guide rails G₁ or G₂ carrying wear strips. However, FIG. 7 shows an arrangement in which the sides of the chain 10 are merely contained by guide rails G₁, G₂ and at least one, and more preferably a plurality of transversely spaced roller supports 50 are present.

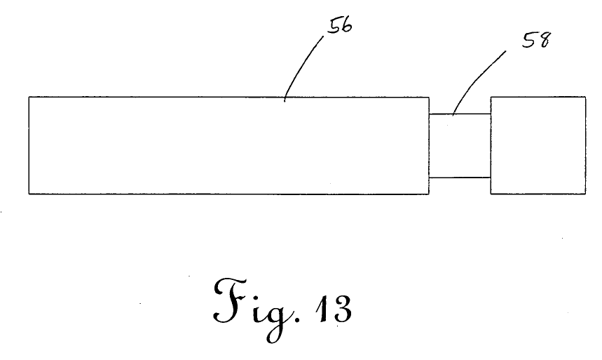

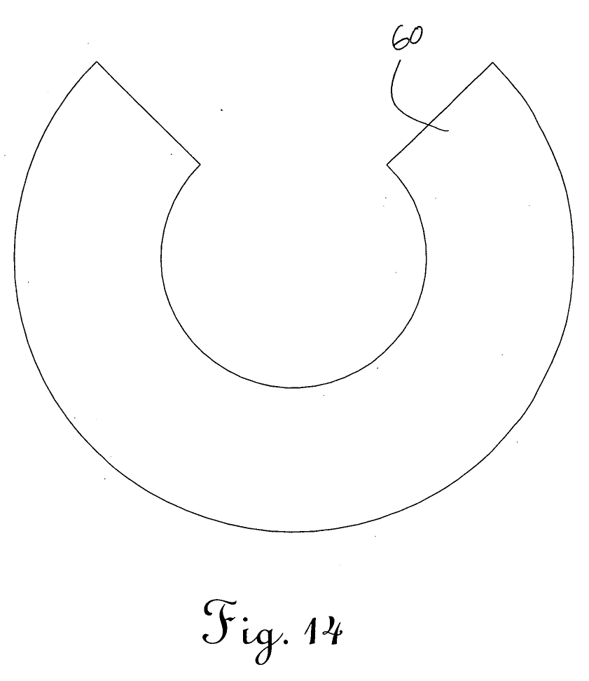

In any case, and with reference now to FIGS. 8-14, one possible embodiment of the roller support 50 is illustrated. In this embodiment, the support 50 includes an elongated rail 54, which in turn supports an axle 56 for at least one corresponding roller 52. The axle 56 in the preferred embodiment comprises a stub shaft including a notch 58 for receiving a retainer 60 (such as a C-clip) for retaining the roller 52, while still permitting free rotation in the conveying direction C. Each axle 56 is mounted in the vertical direction such that the periphery of the corresponding roller 52 projects beyond the rail 54, and thus is capable of engaging the corresponding surface of the belt or chain 10.

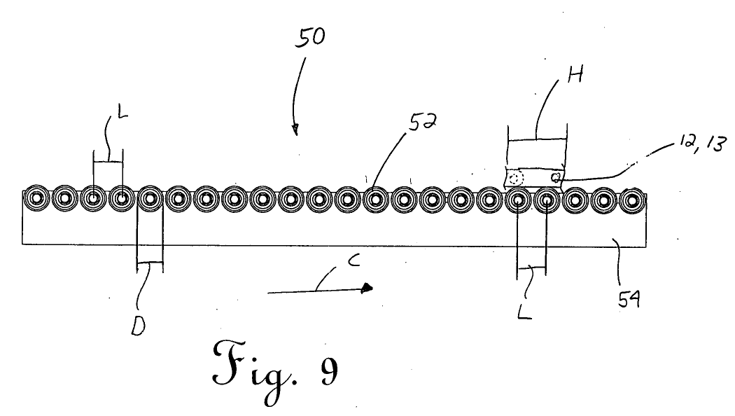

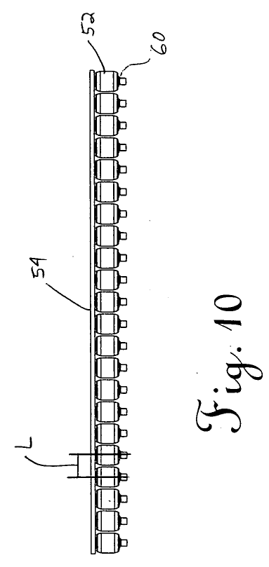

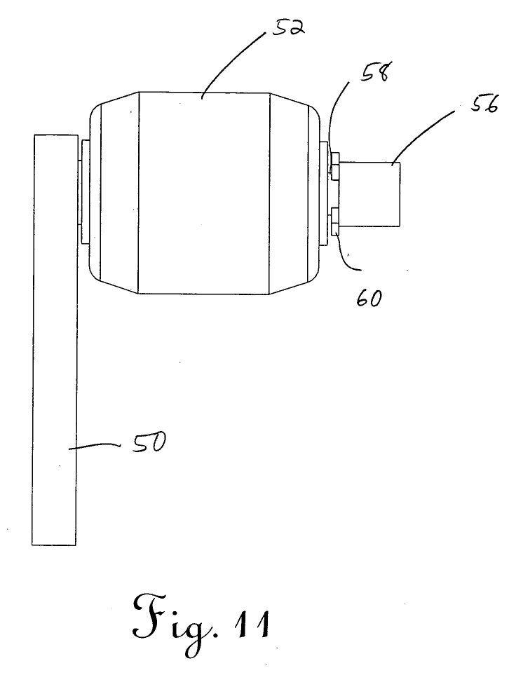

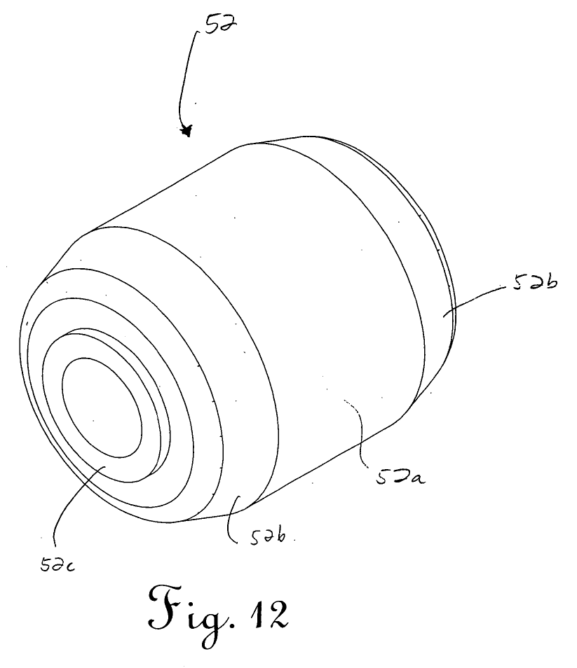

With respect to the horizontal direction, and specifically referring to FIGS. 9 and 10, each axle 56 present is preferably spaced very close to the next-adjacent one and, most preferably, as close as possible without creating any interference between the corresponding rollers 52. For example, as shown in FIG. 9, the centers of the axles 56 are spaced apart a linear distance L less than twice the diameter D of a single roller 52, and preferably just a little more than the diameter. As a result, the rollers 52 provide substantially continuous, low friction support for the chain 10 without interfering with each other.

In another example of close spacing shown along the right hand side of FIG. 9, a center-to-center distance L between of two adjacent rollers 52 in the conveying direction C is less than a corresponding dimension H of the corresponding link 12 or 13 (or stated another way, L<H). As a result, the link 12, 13 is always at least partially supported by at least two rollers 52 as it moves along in the conveying direction D. In situations where the dimension H of the link 12, 13 in the conveying direction C exceeds the linear distance assuming the centers of three of the rollers 52 (approximately 2L, such that H>2L), full support would thus be provided by at least two rollers 52 at all times.

In use, the roller rail 50 is thus mounted along a straight (FIG. 7) or curving (FIG. 5) section of the conveyor system S for engaging a surface of a link 12 forming the chain 10 (such as opposite the conveying surface 11 along the forward run F, or the conveying surface 11 along the return run R, or both) intermediate of the side edges. The rollers 52 thus successively engage one or more links 12 forming the chain 10 along the corresponding run as it traverses along the endless path. Accordingly, full support is provided for the chain 10 with the desirable low friction afforded by axle-mounted, freely rotatable rollers 52.

As a consequence of this low friction support, the power requirements for driving the chain 10 are reduced. This means the forward run F may be extended a significant distance (e.g., 25 feet) without the need for adding a larger or second drive motor. This not only reduces the manufacturing cost (since the motor is sometimes the single most expensive component of the conveyor system), but also the maintenance cost.

With reference to FIG. 12, each roller 52 is preferably barrel-shaped, with a generally circular mid-section 52a bounded by tapered or frusto-conical outer sections 52b. This helps to ensure that smooth contact is maintained with the corresponding surface of the chain 10, and helps to prevent the roller 52 from damaging it. Each roller 52 may also include an annular side projection 52c for engaging either the adjacent surface of the rail 52 or the retainer 60. Preferably, this annular projection 52c is made sufficiently thin to minimize the amount of surface contact that may occur between the roller 52 and the rail 50 or retainer 60 as the result of lateral movement. To maximize their service life, the rollers 52 are preferably made of a low cost, durable material, such as Acetal, Nylon 6-6, or the like.

Turning back to FIG. 7, it is also noted that roller supports 50 may also be provided along the outer sides of the belt or chain 10 (which is shown without any special side links for providing a retaining or guiding function). Instead of a longitudinal “rail,” the rollers 52 may be associated with and supported by the members forming part of the conveyor frame E. The rollers 52 of the side supports 50 thus support the lateral sides of the chain 10 in the desired low friction manner. These side supports 50 may be used in conjunction with or without one or more intermediate roller supports, and thus serve to further increase the benefit afforded in terms of providing the desirable low friction support for the chain 10.

In the illustrated embodiments, the support 50 is shown extending in the longitudinal or conveying direction C. However, it is also possible to provide a support extending in the transverse direction P and supporting one or more rollers for rotation about a stationary axle aligned with the connecting rods of the conveyor chain. This arrangement may be considered advantageous in that the spacing of the rollers in the transverse direction P for adjacent supports may be varied to avoid creating uneven wear patterns in the corresponding surface of the belt or chain.

The foregoing description of various embodiments of the present inventions are presented for purposes of illustration and description. The descriptions provided is not intended to be exhaustive or to limit the inventions to the precise forms disclosed. Obvious modifications or variations are possible in light of the above teachings. For example, the one or more links 12 comprising the belt or chain 10 may be modified to include a flat, substantially continuous surface opposite the conveying surface 11 for engaging the rollers 52 along the forward run (similar to the flat top conveying surface 11 that would engage the rollers 52 along the return run when a chain of type shown in the Applicant's later U.S. Pat. Nos. 6,364,095 and 6,585,110 is used). The embodiments described provide the best illustration of the principles of the inventions and their practical applications to thereby enable one of ordinary skill in the art to utilize the inventions in various embodiments and with various modifications as are suited to the particular use contemplated. All such modifications and variations are within the scope of the disclosed inventions.

1. A conveyor system intended for use in moving one or more articles in at least a conveying direction along an endless path having a forward run and a return run, comprising:
an endless chain having lateral side edges spaced apart in a direction transverse to the conveying direction and including at least one link having a surface intermediate of the side edges; and
a chain support positioned between the side edges and including an axle extending in the transverse direction for rotatably supporting a roller for engaging the surface of the link;
whereby the roller provides enhanced, low friction support for the chain intermediate of the side edges.

2. The conveyor system according to claim 1, wherein the chain support comprises a rail extending in the conveying direction and a plurality of spaced apart axles, each carrying a roller for engaging the surface of the link as the chain moves in the conveying direction.

3. The conveyor system according to claim 2, wherein each axle comprises a stub shaft projecting outwardly from the rail and includes a retainer at one end for retaining the associated roller.

4. The conveyor system according to claim 2, wherein the axles are spaced apart a distance in the conveying direction less than twice the diameter of the associated roller.

5. The conveyor system according to claim 1, wherein the surface of the link for engaging the roller is opposite a conveying surface of the chain.

6. The conveyor system according to claim 1, wherein the surface of the link for engaging the roller is the conveying surface and the support is positioned along the return run.

7. The conveyor system according to claim 1, wherein the chain includes side guide links for engaging corresponding side guide rails extending in the conveying direction and spaced apart in the transverse direction.

8. The conveyor system according to claim 7, wherein the side guide rails carry the chain support.

9. The conveyor system according to claim 7, wherein each side guide link includes a transverse tab for engaging a corresponding one of the side guide rails.

10. The conveyor system according to claim 7, wherein each side guide rail includes at least one roller for providing low friction support along the side edge of the chain.

11. A conveyor system intended for use in moving one or more articles in at least a conveying direction along an endless path having a forward run and a return run, comprising:
an endless chain having lateral side edges formed by rows of modular links, including side and intermediate links, interconnected by a connector extending in a direction transverse to the conveying direction; and
a chain support including an axle extending in the transverse direction for rotatably supporting a roller for engaging a surface of at least one intermediate link as the chain traverses the endless path;
whereby the roller provides enhanced, low friction support for the chain intermediate of the side edges to help prevent sagging.

12. The system of claim 11, wherein the surface of the at least one intermediate link is opposite a conveying surface.

13. The system of claim 11, wherein the surface of the at least one intermediate link is the conveying surface along the return run.

14. The system of claim 11, wherein the support comprises a guide rail extending in the conveying direction.

15. The system of claim 14, wherein the guide rail carries a plurality of closely spaced rollers to provide low friction support for the chain by engaging the surface of the intermediate links as the chain traverses the endless path.

16. The conveyor system according to claim 11, wherein the chain includes side guide links for engaging corresponding side guide rails extending in the conveying direction and spaced apart in the transverse direction.

17. The conveyor system according to claim 16, wherein the side guide rails carry the chain support.

18. The conveyor system according to claim 16, wherein each side guide link includes a depending arm and an inwardly extending transverse tab.

19. The conveyor system according to claim 16, wherein each side guide rail includes at least one roller for providing low friction support along the side edge of the chain.

20. A support arrangement for a modular conveyor chain moving in a conveying direction and including at least one link, comprising:
a longitudinally extending rail including a plurality of rollers spaced in the conveying direction for engaging the chain and providing direct, low-friction support,
wherein a space between the rollers in the conveying direction is less than a dimension of the link in the conveying direction.

21. A support arrangement for a modular conveyor chain moving in a conveying direction and including at least one link, comprising:
a longitudinally extending rail including a plurality of rollers spaced in the conveying direction for engaging the chain and providing direct, low-friction support,
wherein the plurality of rollers simultaneously contact the at least one link.

22. A support arrangement for a modular conveyor chain, comprising:
a support frame including first and second spaced apart side members for at least supporting the chain; and
an intermediate rail positioned between the spaced rails, said rail supporting at least one axle carrying at least one roller for engaging the chain.

23. The support arrangement of claim 22, wherein the intermediate support rail carries a plurality of axles spaced apart in the conveying direction, each carrying a roller for engaging the chain.

24. The support arrangement of claim 22, wherein the side members include wear strips for engaging the conveyor chain.

25. The support arrangement of claim 22, wherein the side members include rollers for engaging the conveyor chain.

26. The support arrangement of claim 22, wherein each axle is a stub axle and includes a retainer for retaining the corresponding roller.

27. The support arrangement of claim 22, wherein the intermediate support rail is carried by the side members.

28. A method of manufacturing a support arrangement for a modular conveyor chain having side edges, comprising:
positioning a longitudinally extending rail between the side edges of the chain, the rail including an axle supporting at least one roller for engaging the chain.

29. A method of manufacturing a conveyor system, comprising:
forming an endless conveyor chain of a plurality of modular links, including by passing a transverse connector through the links to form a row; and
supporting the endless chain, including with a longitudinally extending rail positioned between the side edges of the chain and having an axle supporting a roller for engaging the chain.

30. A method of moving articles, comprising conveying the articles using the conveyor system of claim 22.
